(19) United States
(12) Patent Application Publication
(10) Pub. No.: US 2021/0301566 A1
(43) Pub. Date: Sep. 30, 2021

(54) LID LOCK UNIT ATTACHMENT STRUCTURE

(71) Applicant: TOYODA GOSEI CO., LTD., Kiyosu-shi (JP)

(72) Inventor: Hiroki TAKAI, Kiyosu-shi (JP)

(21) Appl. No.: 17/183,581

(22) Filed: Feb. 24, 2021

(30) Foreign Application Priority Data
Mar. 30, 2020 (JP) 2020-061502

(51) Int. Cl. E05B 83/30; E05C 19/00; E05C 9/08

(52) U.S. Cl. CPC E05B 83/30; E05C 9/085; E05C 19/005

(57) ABSTRACT

In structure for attaching, to an openable/closable lid, a lid lock unit including: a base member attached to the lid back side and having a base shaft portion extending in a predetermined direction; a knob member exposed on the lid front side, having a knob shaft portion shaft-fitted to the base shaft portion, and supported by the base member rotatably between a reference position and an opened position about the knob shaft portion; and an open/close mechanism for opening the lid by the knob member rotating from the reference position to the opened position, the base member includes a base extending portion extending in a direction crossing the predetermined direction, from a side opposed to the lid, and the lid includes a lid extending portion extending in the crossing direction from the back side of the lid and located adjacently to a predetermined-direction outer side of the base extending portion.

### TECHNICAL FIELD

The present invention relates to a lid lock unit attachment structure.

### BACKGROUND ART

Conventionally, there has been known a lid lock unit of a glovebox mounted on a vehicle, for example (for example, JP2007-100343A). This lid lock unit is a device for opening a lid of the glovebox by an operator's knob operation and moving the lid to a closed position by an operator's pushing operation to the lid. The lid lock unit includes a base member, a knob member, and an open/close mechanism.

The base member is fixed to the back side of the lid of the glovebox. The base member has a shaft body as a base shaft portion extending in a predetermined direction. The shaft body protrudes outward in the axial direction from a base part. The knob member is exposed on the front side of the lid. The knob member has a shaft hole as a knob shaft portion shaft-fitted to the base shaft portion, and is supported by the base member. A pair of the shaft bodies of the base members are provided so as to be separated from each other in the axial direction. A pair of the shaft holes of the knob members are provided so as to be separated from each other in the axial direction. Each shaft hole is located on the axially outer side of the corresponding shaft body. The shaft hole and the shaft body corresponding to each other are shaft-fitted to each other.

The open/close mechanism is a mechanism for opening the lid when the knob member is rotated from a reference position to an opened position, and locking the lid at the closed position when the opened lid is pushed by the operator after the rotating operation is canceled. Specifically, the open/close mechanism achieves opening/closing of the lid by advancing/retracting a latch rod through a rotating operation to the knob member and a pushing operation to the lid. The open/close mechanism has an energization member for generating a force to energize a latch rod toward the lid closed position side. Through the operator's rotating operation, the knob member is rotated from the reference position to the opened position against the energization force of the energization member, whereby the latch rod is pulled out from a vehicle body opening edge engaging with the latch rod and thus the lid is opened.

### SUMMARY OF INVENTION

### Technical Problem

As described above, the shaft body of the base member and the shaft hole of the knob member are shaft-fitted to each other. In general, rotation of the knob member is permitted within a range between the reference position and the opened position, and outside this range, the knob member is restricted by contacting with the base member. However, if the knob member is, for example, excessively rotated beyond the restriction so that a force of causing axis-misalignment between the shaft hole of the knob member and the shaft body of the base member is exerted, there is a risk that shaft fitting parts of the shaft body and the shaft hole are deformed and the knob member comes off the base member.

Regarding this phenomenon, if a lap amount between the shaft fitting parts of the shaft body and the shaft hole is increased, the knob member is prevented from coming off the base member, even when the above excessive rotating operation is performed. However, in this configuration, due to the increase of the lap amount between the shaft body and the shaft hole, the resistance of attachment of the knob member to the base member increases, so that ease of the attachment is reduced.

The present invention has been made in view of the above circumstances, and an object of the present invention is to provide a lid lock unit attachment structure in which a knob member is less likely to come off a base member when the knob member is rotated, without reducing ease of attachment of the knob member to the base member.

### Solution to Problem

An aspect of the present invention is directed to a lid lock unit attachment structure for attaching a lid lock unit to a lid that is openable/closable, the lid lock unit comprising: a base member located and attached on a back side of the lid, and having a base shaft portion extending in a predetermined direction; a knob member exposed on a front side of the lid and having a knob shaft portion shaft-fitted to the base shaft portion, the knob member being supported by the base member rotatably between a reference position and an opened position about the knob shaft portion; and an open/close mechanism configured to open the lid through rotation of the knob member from the reference position to the opened position, wherein the base member includes a base extending portion extending in a crossing direction crossing the predetermined direction, from a side opposed to the lid, and the lid includes a lid extending portion extending in the crossing direction from the back side of the lid and located adjacently to an outer side in the predetermined direction of the base extending portion.

In this configuration, after the base member is attached to the back side of the lid, deformation of the base member to extend in the predetermined direction is restricted by the base extending portion contacting with the lid extending portion, and after the contact, the resistance against the force of deforming the base member to extend in the predetermined direction is increased. Thus, deformation of the shaft fitting parts of the knob shaft portion and the base shaft portion is restricted owing to the above deformation restriction of the base member. Therefore, the knob member is less likely to come off the base member even when the knob member is excessively rotated. In this case, the lap amount between the knob shaft portion and the base shaft portion at the shaft fitting parts need not be increased. Thus, without reduction in ease of attachment of the knob member to the base member, the knob member is less likely to come off the base member when the knob member is rotated.

### BRIEF DESCRIPTION OF DRAWINGS

FIG. 1 is a perspective view of a glovebox to which a lid lock unit according to an embodiment is applied;

FIG. 2 is a front view of the lid lock unit according to the embodiment;

FIG. 3 is an exploded perspective view of the lid lock unit according to the embodiment;

FIG. 4 is a sectional view of the lid lock unit according to the embodiment along line IV-IV shown in FIG. 2;

FIG. 5 is a sectional view of the lid lock unit according to the embodiment along line V-V shown in FIG. 2;

FIG. 6 is an enlarged sectional view of a specific part of the lid lock unit shown in FIG. 5;

FIG. 7 is a specific part perspective view of the lid according to the embodiment as seen from the back side; and

FIG. 8 is a specific part perspective view of the lid according to a modification as seen from the back side.

### DESCRIPTION OF EMBODIMENTS

Hereinafter, with reference to the drawings, specific embodiments of a lid lock unit attachment structure according to the present invention will be described.

An attachment structure for a lid lock unit 1 according to an embodiment is applied to a glovebox 10 of a vehicle. The glovebox 10 is, for example, a storage container mounted to an interior member (not shown) such as an instrument panel in front of a front passenger seat in a vehicle compartment, and is opened/closed with respect to the interior member.

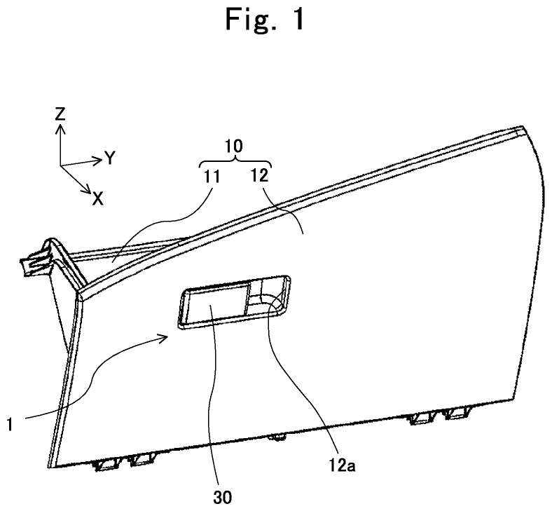

The glovebox 10 is openably/closably stored in an opening (not shown) provided in the interior member. The glovebox 10 includes a storage portion 11 and a lid 12, as shown in FIG. 1. The storage portion 11 is a case-shaped part for storing items such as a book and a booklet, and is located on the deep side in the opening of the interior member when the glovebox 10 is closed. The lid 12 is a plate-shaped part located on the front side of the storage portion 11, and when the glovebox 10 is closed, the front surface of the lid 12 is exposed to the inside of the vehicle compartment and becomes flush with the interior member.

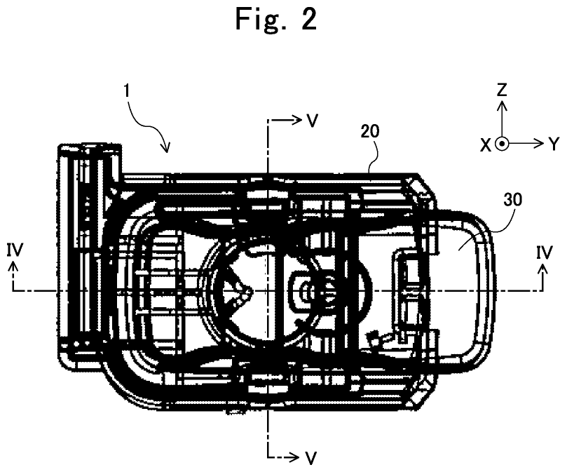

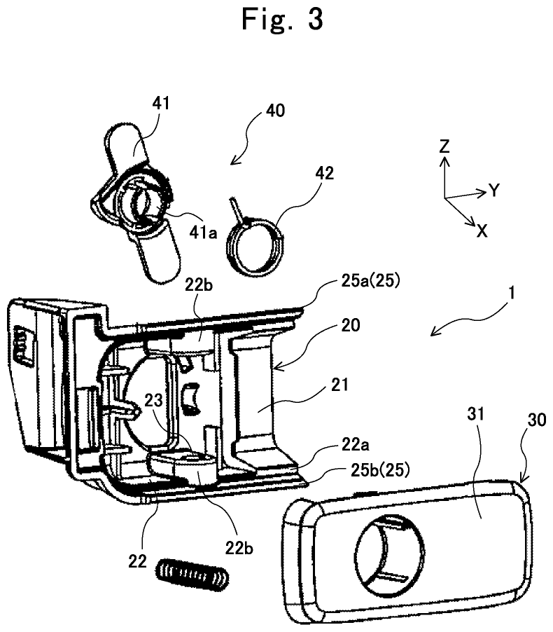

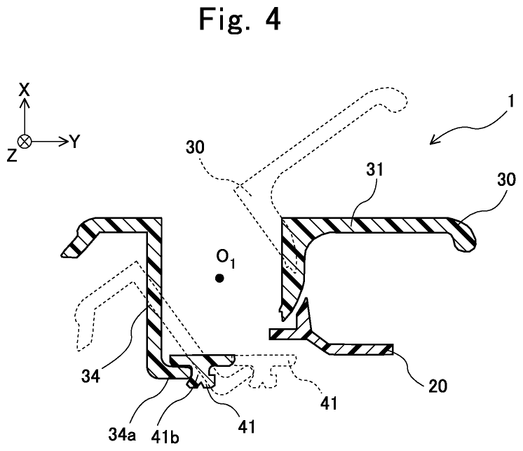

The lid lock unit 1 includes a base member 20, a knob member 30, and an open/close mechanism 40, as shown in FIG. 1, FIG. 2, FIG. 3, and FIG. 4.

The base member 20 is a member fixed to the lid 12 of the glovebox 10. The base member 20 is formed in a substantially quadrangular plate shape. The base member 20 is located and attached on the back side opposite to the front surface of the lid 12. The base member 20 includes a plate portion 21, horizontal portions 22, and base shaft portions 23.

The plate portion 21 is a plate-shaped part extending in parallel to the back surface of the lid 12. The plate portion 21 is formed in a substantially quadrangular shape. The plate portion 21 has a through hole 21a at the center. The through hole 21a is a hole through which a part of a lock mechanism for locking the knob member 30 and the lid 12 at a closed position, and the like, pass.

The horizontal portions 22 are plate-shaped parts protruding from the plate portion 21 in a direction (hereinafter, referred to as X direction, as appropriate) to approach the lid back surface in the horizontal direction. The horizontal portions 22 are provided at upper and lower two locations of the plate portion 21, and extend in a direction (hereinafter, referred to as Y direction, as appropriate) along the upper side line and the lower side line of the plate portion 21. Flange portions 22a are provided at ends of the horizontal portions 22. The flange portions 22a extend from the bodies of the horizontal portions 22 toward the outer sides away from the bodies in the up-down direction (hereinafter, referred to as Z direction, as appropriate). The upper and lower two horizontal portions 22 are respectively provided with cylindrical support portions 22b. The X direction, the Y direction, and the Z direction described above are directions crossing each other, specifically, directions perpendicular to each other.

The base shaft portions 23 are shaft holes extending in the up-down direction (i.e., Z direction) and having a circular sectional shape. The base shaft portions 23 are formed at the support portions 22b. The base shaft portions 23 are provided at upper and lower two locations. The upper base shaft portion 23 is provided at the support portion 22b of the upper horizontal portion 22, and opens at the lower surface of this support portion 22b. The lower base shaft portion 23 is provided at the support portion 22b of the lower horizontal portion 22, and opens at the upper surface of this support portion 22b. A space is formed between the upper and lower two support portions 22b. The upper and lower two base shaft portions 23 are provided coaxially with each other with the space interposed therebetween.

The knob member 30 is an operation portion for opening the lid 12 and therefore the glovebox 10 by an operator inserting a finger between the knob member 30 and the front surface of the lid 12 and pulling one end side (right side in FIG. 1 and FIG. 2) of the knob member 30 to the near side. The knob member 30 is formed in a plate shape. The knob member 30 is located at a lid opening 12a provided in the lid 12, and is exposed on the front side of the lid 12. The knob member 30 may be configured to hold a cylinder key of the aforementioned lock mechanism. The knob member 30 has a plate portion 31, shaft support portions 32, knob shaft portions 33, and an arm contact portion 34.

The plate portion 31 is a plate-shaped part extending in parallel to the front surface of the lid 12. The plate portion 31 is an operation portion to be touched by a hand or a finger at the time of an operation by the operator. The shaft support portions 32 are parts protruding from the plate portion 31 in the direction (i.e., X direction) to approach the lid front surface in the horizontal direction. The shaft support portions 32 are provided at upper and lower two locations of the plate portion 31. Each shaft support portion 32 may be a part of a cylindrical side wall in which the cylinder key is stored.

The knob shaft portions 33 are columnar shaft bodies extending in the up-down direction (i.e., Z direction). The knob shaft portions 33 are formed at the shaft support portions 32. The knob shaft portions 33 are provided at upper and lower two locations. The upper knob shaft portion 33 is provided at the upper shaft support portion 32 and protrudes upward from this shaft support portion 32. The lower knob shaft portion 33 is provided at the lower shaft support portion 32, and protrudes downward from this shaft support portion 32. The knob member 30 is partially fittable to the space between the upper and lower two support portions 22b of the base member 20 so as to be sandwiched between both support portions 22b. The knob shaft portions 33 of the knob member 30 are shaft-fitted to the base shaft portions 23 of the base member 20.

When the above shaft-fitting has been made, the knob member 30 is supported rotatably about the knob shaft portions 33 (about a rotation center O1 shown in FIG. 4) with respect to the base member 20. The knob member 30 is rotatable between a reference position where the plate portion 31 is parallel to the front surface of the lid 12, and an opened position where the plate portion 31 is inclined at a predetermined angle with respect to the front surface of the lid 12.

The arm contact portion 34 is a part contacting with a later-described arm member of the open/close mechanism 40 to transmit rotation of the knob member 30 to the arm member. The arm contact portion 34 is provided on the back surface of the plate portion 31, and is located on the opposite side across the rotation center O1 from a part to be touched when the operator operates (specifically, pulls) the knob member 30. The arm contact portion 34 extends from the plate portion 31 of the knob member 30 in the direction (i.e., X direction) to approach the front surface of the lid 12 in the horizontal direction. A distal end 34a of the arm contact portion 34 is bent from the body of the arm contact portion 34 so as to be parallel to the plate portion 31.

The knob member 30 is rotatable about the knob shaft portions 33 from the reference position to the opened position where the lid 12 is opened. Rotation of the knob member 30 is permitted within a range between the reference position and the above opened position, and outside this range, rotation of the knob member 30 is restricted by contact between a predetermined part of the knob member 30 and a predetermined part of the base member 20.

The open/close mechanism 40 is a mechanism for opening the lid 12 when the knob member 30 is rotated from the reference position to the opened position, and locking the lid 12 at the closed position when the opened lid 12 is pushed by the operator after the rotating operation is canceled. The open/close mechanism 40 includes an arm member 41 and an energization member 42.

The arm member 41 is a member swingable with respect to the base member 20. The arm member 41 is located on the back side of the base member 20. The arm member 41 has a cylindrical shaft portion 41a. The shaft portion 41a is provided at the center in the arm longitudinal direction. The shaft portion 41a is inserted into a shaft portion provided on the back surface of the base member 20. The arm member 41 is swingably supported by the base member 20 at the center in the arm longitudinal direction.

Ends of latch rods (not shown) extending in a rod shape are respectively connected to an upper end and a lower end across the shaft portion 41a of the arm member 41. This pair of latch rods are members for opening/closing the lid 12 and therefore the glovebox 10. The other ends of the latch rods are each engageable/disengageable with/from an opening edge of the interior member. The arm member 41 is swingable between a lock position that allows the lid 12 to be retained in a locked state and a lock release position where the locked state of the lid 12 is released, while the pair of latch rods synchronously advance/retract relative to the interior member from the lid 12.

Swing of the arm member 41 is permitted within a range between the lock position and the lock release position, and outside this range, swing of the arm member 41 may be restricted by contact between a predetermined part of the arm member 41 and a predetermined part of the base member 20. Instead of or in addition to the restriction of swing of the arm member 41 beyond the lock position by contact of the arm member 41 itself, swing of the arm member 41 beyond the lock position may be restricted by the latch rods contacting with the interior member side and being prevented from further advancing during swing of the arm member 41.

The arm member 41 has a knob contact portion 41b. The knob contact portion 41b is a part with which the arm contact portion 34 of the knob member 30 contacts. The knob contact portion 41b protrudes from the back surface of the body of the arm member 41 so that the distal end 34a of the arm contact portion 34 of the knob member 30 is caught thereon.

The energization member 42 is a coil spring that generates an energization force of swinging the arm member 41 to the lock position thereby engaging the latch rods with the interior member and rotating the knob member 30 to the reference position. The energization member 42 is placed such that the shaft portion 41a of the arm member 41 is inserted therein. The energization member 42 has one end engaged with the base member 20 and another end engaged with the arm member 41.

Next, operation of the lid lock unit 1 will be described.

In the lid lock unit 1, in a state in which the knob member is not rotated from the reference position to the opened position, the knob member 30 is retained at the closed position and the arm member 41 is retained at the lock position, by the energization force of the energization member 42, and the latch rods are advanced from the glovebox 10 to the interior member side so as to be engaged with the interior member. In this case, the glovebox 10 is closed.

In the above state in which the glovebox 10 is closed, if the knob member 30 is rotated toward the opened position, the arm contact portion 34 of the knob member 30 contacts with the knob contact portion 41b of the arm member 41, whereby the arm member 41 swings from the lock position toward the lock release position against the energization force of the energization member 42. Then, when the arm member 41 has swung to the lock release position, the latch rods retract to the glovebox 10 side so that the engagement with the interior member side is released and thus the glovebox 10 is opened.

After the glovebox 10 is opened as described above, if the operation of rotating the knob member 30 to the opened position is canceled, the arm member 41 swings toward the lock position by the energization force of the energization member 42. In this case, the latch rods advance outward from the glovebox 10, to come into a state of being engageable with the interior member side.

Then, if the glovebox 10 is pushed from an opened state to a closed state by the operator, during this operation, immediately before the latch rods are engaged with the interior member side, the latch rods are pressed from the interior member side to the retraction side at positions where the latch rods protrude outward from the glovebox 10, so that the latch rods slightly retract to the glovebox 10 side against the energization force of the energization member 42. As a result of this retraction, the arm member 41 swings from the lock position toward the lock release position. Then, when the force of pressing the latch rods from the interior member side to the retraction side is no longer exerted, the arm member 41 swings toward the lock position by the energization force of the energization member 42, and the latch rods advance to the interior member side again. In this case, the latch rods are engaged with the interior member side and thus the glovebox 10 is closed.

Next, a specific part of the lid lock unit 1 will be described.

In the above lid lock unit 1, the knob shaft portions 33 of the knob member 30 are shaft-fitted to the base shaft portions 23 of the base member 20, whereby the knob member 30 is rotatably supported by the base member 20. Rotation of the knob member 30 is permitted within a range between the reference position and the opened position, and outside this range, rotation of the knob member 30 is restricted by contact with the base member 20. The base member 20 is located and attached on the back side of the lid 12 of the glovebox 10.

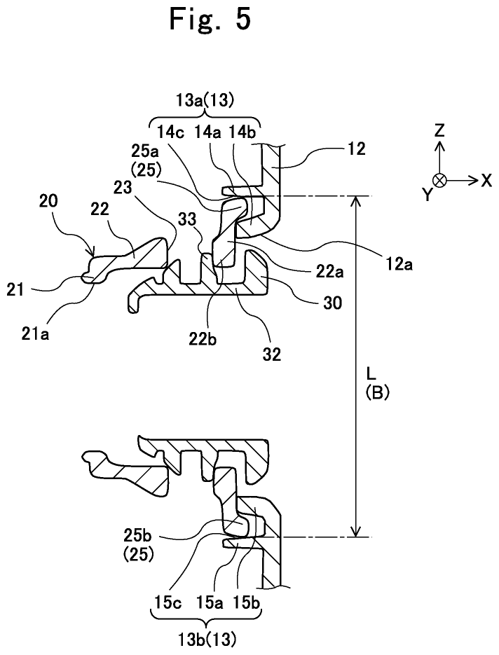

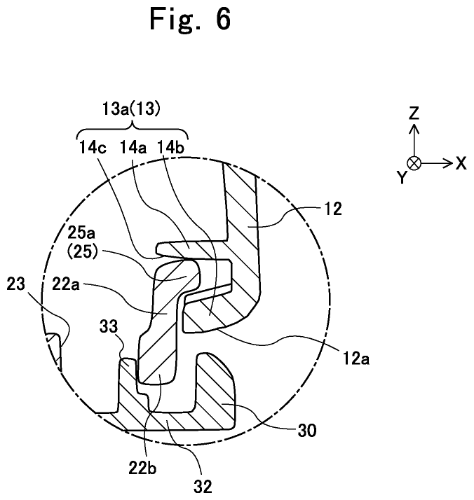

The base member 20 has base extending portions 25 as shown in FIG. 5 and FIG. 6. The base extending portions 25 are parts extending from the side opposed to the lid 12 on the base member 20 toward the lid back surface, in the X direction crossing the Z direction which is the up-down direction. The base extending portions 25 are provided at upper and lower two locations, and are respectively provided at outer ends of the flange portions 22a of the upper and lower two horizontal portions 22. The base extending portions 25 extend in a line shape along the back surface of the lid 12 so as to be opposed to the back surface of the lid 12.

Hereinafter, the base extending portion 25 provided at the upper horizontal portion 22 is referred to as first base extending portion 25a, and the base extending portion 25 provided at the lower horizontal portion 22 is referred to as second base extending portion 25b. The first base extending portion 25a and the second base extending portion 25b are paired and separated from each other in the Z direction.

The base member 20 is elastically deformable in the Z direction. Specifically, the base member 20 is elastically deformable so that a Z-direction separation distance B between the first base extending portion 25a and the second base extending portion 25b is variable. The above Z-direction separation distance B can be shorter than a natural length B0 when an external force is not exerted on the base member 20.

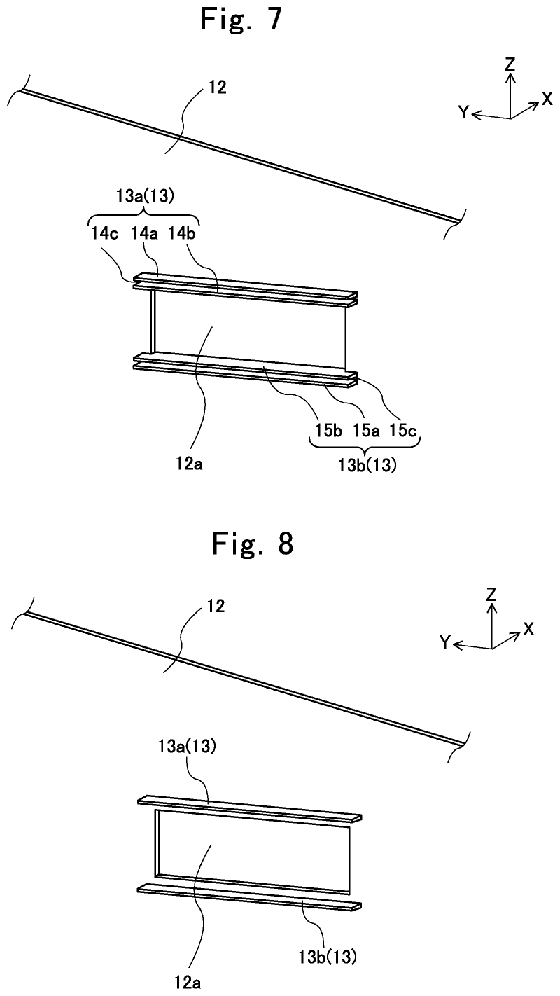

The lid 12 has lid extending portions 13 as shown in FIG. 5, FIG. 6, and FIG. 7. The lid extending portions 13 are parts extending from the back side of the lid 12 toward the base member 20 side in the X direction crossing the Z direction which is the up-down direction. The lid extending portions 13 are provided for attaching the base member 20 to the lid 12. The lid extending portions 13 are provided at upper and lower two locations corresponding to the first base extending portion 25a and the second base extending portion 25b of the base member 20. The lid extending portions 13 extend in a line shape along the back surface of the lid 12.

Hereinafter, the upper lid extending portion 13 is referred to as first lid extending portion 13a, and the lower lid extending portion 13 is referred to as second lid extending portion 13b. The first lid extending portion 13a and the second lid extending portion 13b are paired and separated from each other in the Z direction. A Z-direction separation distance L between the first lid extending portion 13a and the second lid extending portion 13b is a predetermined fixed value, and is set to be smaller than the natural length B0 of the Z-direction separation distance B between the first base extending portion 25a and the second base extending portion 25b described above.

The first lid extending portion 13a is located adjacently to the outer side in the Z direction (specifically, upper side) of the first base extending portion 25a. The second lid extending portion 13b is located adjacently to the outer side in the Z direction (specifically, lower side) of the second base extending portion 25b. That is, the base member 20 is attached to the lid 12 so that the first base extending portion 25a and the second base extending portion 25b are accommodated between the first lid extending portion 13a and the second lid extending portion 13b.

The above attachment of the base member 20 to the lid 12 is performed in a state in which the base member 20 is elastically deformed by an external force so that the above Z-direction separation distance B becomes smaller than the natural length B0. When the attachment is completed and the external force to the base member 20 is canceled, by the elastic force of the base member 20, the outer surface in the Z direction (specifically, upper surface) of the first base extending portion 25a contacts with the inner surface in the Z direction (specifically, lower surface) of the first lid extending portion 13a, and the outer surface in the Z direction (specifically, lower surface) of the second base extending portion 25b contacts with the inner surface in the Z direction (specifically, upper surface) of the second lid extending portion 13b.

Each lid extending portion 13 is formed in a forked shape so as to sandwich the base extending portion 25 of the base member 20 in the Z direction. That is, the first lid extending portion 13a has a pair of extending piece portions 14a, 14b, and a retention groove 14c. In addition, the second lid extending portion 13b has a pair of extending piece portions 15a, 15b, and a retention groove 15c.

The extending piece portions 14a, 14b of the first lid extending portion 13a extend in the X direction from the back side of the lid 12. The extending piece portions 14a, 14b are separated from each other to the upper and lower sides with the retention groove 14c interposed therebetween, so as to store the first base extending portion 25a therebetween. The retention groove 14c is a groove into which the first base extending portion 25a is inserted and fitted. The extending piece portions 14a, 14b and the retention groove 14c extend in a line shape in the Y direction along the back surface of the lid 12.

The extending piece portions 15a, 15b of the second lid extending portion 13b extend in the X direction from the back side of the lid 12. The extending piece portions 15a, 15b are separated from each other to the upper and lower sides with the retention groove 15c interposed therebetween, so as to store the second base extending portion 25b therebetween. The retention groove 15c is a groove into which the second base extending portion 25b is inserted and fitted. The extending piece portions 15a, 15b and the retention groove 15c extend in a line shape in the Y direction along the back surface of the lid 12.

In a state in which the base member 20 is attached to the lid 12, the upper surface of the first base extending portion 25a contacts with the lower surface of the upper extending piece portion 14a of the extending piece portions 14a, 14b of the first lid extending portion 13a, and the lower surface of the second base extending portion 25b contacts with the upper surface of the lower extending piece portion 15a of the extending piece portions 15a, 15b of the second lid extending portion 13b.

The above Z-direction separation distance L between the first lid extending portion 13a and the second lid extending portion 13b is, specifically, a Z-direction separation distance between the lower surface of the upper extending piece portion 14a of the first lid extending portion 13a and the upper surface of the lower extending piece portion 15a of the second lid extending portion 13b. In addition, the above Z-direction separation distance B between the first base extending portion 25a and the second base extending portion 25b is, specifically, a Z-direction separation distance between the upper surface of the first base extending portion 25a and the lower surface of the second base extending portion 25b.

The attachment of the base member 20 to the lid 12 may be achieved by sliding the base member 20 along the back surface of the lid 12 in the Y direction parallel to the back surface in a state in which the first base extending portion 25a of the base member 20 is inserted into the retention groove 14c between the pair of the extending piece portions 14a, 14b of the first lid extending portion 13a and the second base extending portion 25b is inserted into the retention groove 15c between the pair of extending piece portions 15a, 15b of the second lid extending portion 13b. This configuration enables attachment of the base member 20 to the lid 12 to be easily performed.

In the above lid lock unit 1, attachment of the base member 20 to the back side of the lid 12 is performed such that the lid extending portions 13 of the lid 12 are located adjacently to the outer sides in the Z direction of the base extending portions 25 of the base member 20. In this attachment structure, after the attachment, deformation of the base member 20 to extend in the Z direction is restricted by the upper and lower two base extending portions 25a, 25b respectively contacting with the upper extending piece portion 14a of the first lid extending portion 13a and the lower extending piece portion 15a of the second lid extending portion 13b, and after the contact, the resistance against the force of deforming the base member 20 to extend in the Z direction is increased.

Therefore, even when the knob member 30 is, for example, excessively rotated about the rotation center O1 extending in the Z direction and a force of causing axis-misalignment between the knob shaft portions 33 of the knob member 30 and the base shaft portions 23 of the base member 20 is exerted so that the shaft fitting parts of the knob shaft portion 33 and the base shaft portion 23 are deformed, the deformation of the shaft fitting parts is restricted owing to the deformation restriction of the base member 20 described above, whereby the deformation of the shaft fitting parts is suppressed. Thus, even when a force of causing axis-misalignment between the knob shaft portions 33 of the knob member 30 and the base shaft portions 23 of the base member 20 is exerted by the rotation of the knob member 30, the knob member 30 is less likely to come off the base member 20.

In particular, the above attachment of the base member 20 to the back side of the lid 12 is performed such that the lid extending portions 13 of the lid 12 are located in contact with the outer sides in the Z direction of the base extending portions 25 of the base member 20. Therefore, after the attachment, the base member 20 is prevented from being deformed to extend in the Z direction, and the resistance against the force of deforming the base member 20 in the Z direction is further increased. Thus, even when the knob member 30 is excessively rotated, the deformation margin of the knob member 30 is restricted to be minimized, whereby reliability of preventing the knob member 30 from coming off the base member 20 is improved.

In this regard, in order that the knob member 30 is less likely to come off the base member 20 when the knob member 30 is rotated, the lap amount between the shaft fitting parts of the knob shaft portions 33 of the knob member 30 and the base shaft portions 23 of the base member 20 need not be increased. Therefore, in attachment of the knob member 30 to the base member 20, increase of the attachment resistance due to increase of the lap amount is not caused and thus ease of attachment is ensured.

As described above, with the attachment structure for the lid lock unit 1 of the present embodiment, the knob member 30 is less likely to come off the base member 20 when the knob member 30 is rotated, while ease of attachment of the knob member 30 to the base member 20 is not reduced.

Each lid extending portion 13 of the lid 12 is formed in a forked shape so as to sandwich the base extending portion 25 of the base member 20 in the Z direction. With this structure, after the base member 20 is attached to the back side of the lid 12, deformation of the base member 20 to contract in the Z direction is restricted by the upper and lower two base extending portions 25a, 25b respectively contacting with the lower extending piece portion 14b of the first lid extending portion 13a and the upper extending piece portion 15b of the second lid extending portion 13b, and after the contact, the resistance against the force of deforming the base member 20 to contract in the Z direction is increased. Thus, after the above attachment, the base member 20 is prevented from becoming likely to come off the lid 12 due to vehicle vibration or the like.

In the above embodiment, the Z-direction separation distance L between the first lid extending portion 13a and the second lid extending portion 13b of the lid 12 is set to be smaller than the natural length B0 of the Z-direction separation distance B between the first base extending portion 25a and the second base extending portion 25b of the base member 20. However, the present invention is not limited thereto, and the Z-direction separation distance L may be equal to or greater than the natural length B0. The Z-direction separation distance L has only to be set to such a distance that, when the knob member 30 is excessively rotated, the base extending portions 25 of the base member 20 contact with the lid extending portions 13 of the lid 12, whereby the knob member 30 is prevented from coming off the base member 20.

In the above embodiment, each lid extending portion 13 of the lid 12 is formed in a forked shape so as to sandwich the base extending portion 25 of the base member 20 in the Z direction. However, the present invention is not limited thereto, and each base extending portion 25 of the base member 20 may be formed in a forked shape so as to sandwich the lid extending portion 13 of the lid 12 in the Z direction.

In the above embodiment, each lid extending portion 13 is formed in a forked shape so as to sandwich the base extending portion 25 of the base member 20 in the Z direction. However, the present invention is not limited thereto. As shown in FIG. 8, the first lid extending portion 13a and the second lid extending portion 13b may be respectively formed so as to have only parts that are adjacent to the outer sides in the Z direction of the base extending portions 25 of the base member 20.

The present invention is not limited to the embodiment described above, and various changes may be made without departing from the gist of the present invention.

1. A lid lock unit attachment structure for attaching a lid lock unit to a lid that is openable/closable, the lid lock unit comprising:
a base member located and attached on a back side of the lid, and having a base shaft portion extending in a predetermined direction;
a knob member exposed on a front side of the lid and having a knob shaft portion shaft-fitted to the base shaft portion, the knob member being supported by the base member rotatably between a reference position and an opened position about the knob shaft portion; and
an open/close mechanism configured to open the lid through rotation of the knob member from the reference position to the opened position, wherein
the base member includes a base extending portion extending in a crossing direction crossing the predetermined direction, from a side opposed to the lid, and
the lid includes a lid extending portion extending in the crossing direction from the back side of the lid and located adjacently to an outer side in the predetermined direction of the base extending portion.

2. The lid lock unit attachment structure according to claim 1, wherein
the base extending portion includes a first base extending portion and a second base extending portion paired and separated from each other in the predetermined direction,
the lid extending portion includes a first lid extending portion and a second lid extending portion paired and separated from each other in the predetermined direction,
the first lid extending portion is located adjacently to an outer side in the predetermined direction of the first base extending portion, and
the second lid extending portion is located adjacently to an outer side in the predetermined direction of the second base extending portion.

3. The lid lock unit attachment structure according to claim 1, wherein
the base member is elastically deformable in the predetermined direction, and
the base member is attached and fixed to the lid in such a manner that an outer surface in the predetermined direction of the base extending portion contacts with an inner surface in the predetermined direction of the lid extending portion.

4. The lid lock unit attachment structure according to claim 1, wherein
the base extending portion extends in a line shape along a back surface of the lid so as to be opposed to the back surface of the lid, and
the lid extending portion extends in a line shape along the back surface of the lid.

5. The lid lock unit attachment structure according to claim 1, wherein
one of the base extending portion and the lid extending portion is formed in a forked shape so as to sandwich the other one in the predetermined direction.
